(19) United States
(12) Patent Application Publication
(10) Pub. No.: US 2025/0165756 A1
(43) Pub. Date: May 22, 2025

(54) RESOURCE-EFFICIENT DIFFUSION MODELS

(71) Applicant: Google LLC, Mountain View, CA (US)

(72) Inventors: Yang Zhao, Bothell, WA (US); Yanwu Xu, Boston, MA (US); Zhisheng Xiao, Bellevue, WA (US); Tingbo Hou, Santa Clara, CA (US)

(21) Appl. No.: 18/949,875

(22) Filed: Nov. 15, 2024

Related U.S. Application Data
(60) Provisional application No. 63/600,636, filed on Nov. 17, 2023.

(51) Int. Cl. G06N 3/0475; G06N 3/0464

(52) U.S. Cl. CPC G06N 3/0475; G06N 3/0464

(57) ABSTRACT

Methods, systems, and apparatus, including computer programs encoded on computer storage media, for generating a data item by performing a single-step denoising process using a diffusion model neural network. For example, the data items can be images, videos, audio waveforms, sensor outputs, and so on.

### CROSS-REFERENCE TO RELATED APPLICATIONS

This application claims priority to U.S. Provisional Application No. 63/600,636, filed on Nov. 17, 2023. The disclosure of the prior application is considered part of and are incorporated by reference in the disclosure of this application.

### BACKGROUND

This specification relates to generating data items using neural networks. For example, the data items can include textual data items, audio data items, image data items, video data items, and so on.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes an inference system implemented as computer programs on one or more computers in one or more locations that generates data items. The inference system can generate any of a variety of different types of data items, e.g., images, videos, audio waveforms, sensor outputs, and so on.

In particular, the inference system can generate high-dimensional data items, e.g., high resolution images, in a highly computational efficient manner. This enables the data item generation process to be performed by consumer hardware of end users rather than being performed in a datacenter.

For example, the inference system can achieve a sub-second inference speed for generating a 512×512 image, i.e., generate a 512×512 image in less than one second (measured in wall clock time), when implemented on a mobile computing device.

The subject matter described in this specification can be implemented in particular embodiments so as to realize one or more of the following advantages. Techniques described in this specification can be used to implement a diffusion model neural network that has a particular architecture that allows it to generate data items by performing a single-step reverse diffusion process with reduced redundancy and reduced resource consumption, e.g., reduced processing power and memory consumption.

In particular, by consolidating self-attention layers within the intermediate blocks of the diffusion model neural network, and by using depth-wise separable convolution layers within blocks across the diffusion model neural network, the diffusion model neural network described in this specification has a smaller model size and is computationally more efficient than other diffusion model neural networks, e.g., diffusion model neural networks that have self-attention layers within either the initial or final blocks, or that replace depth-wise separable convolution layers with conventional convolution layers, while still being able to generate data items with comparative quality.

In addition, the reduction in resource consumption may allow the diffusion model neural network to run locally on a mobile computing device with limited computational power or resources, e.g., a smartphone or a tablet. Therefore, the diffusion model neural network, as described in this specification, is more practical than other diffusion model neural networks that are computationally too demanding to run on a mobile computing device to generate data items with comparable quality. Additionally, using the adversarial fine-tuning techniques also described in this specification to train such a diffusion model neural network can ensure that it can generate data items with comparative quality to those other diffusion model neural networks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system and an example inference system.

FIG. 2 is an example illustration of operations performed by a training system to train a diffusion model neural network.

FIG. 3 shows examples of a neural network architecture of a diffusion model neural network.

FIG. 4 is a flow diagram of an example process for training a diffusion model neural network.

FIG. 5 is a flow diagram of an example process for generating a data item by using a diffusion model neural network.

Like reference numbers and designations in the various drawings indicate like elements.

### DETAILED DESCRIPTION

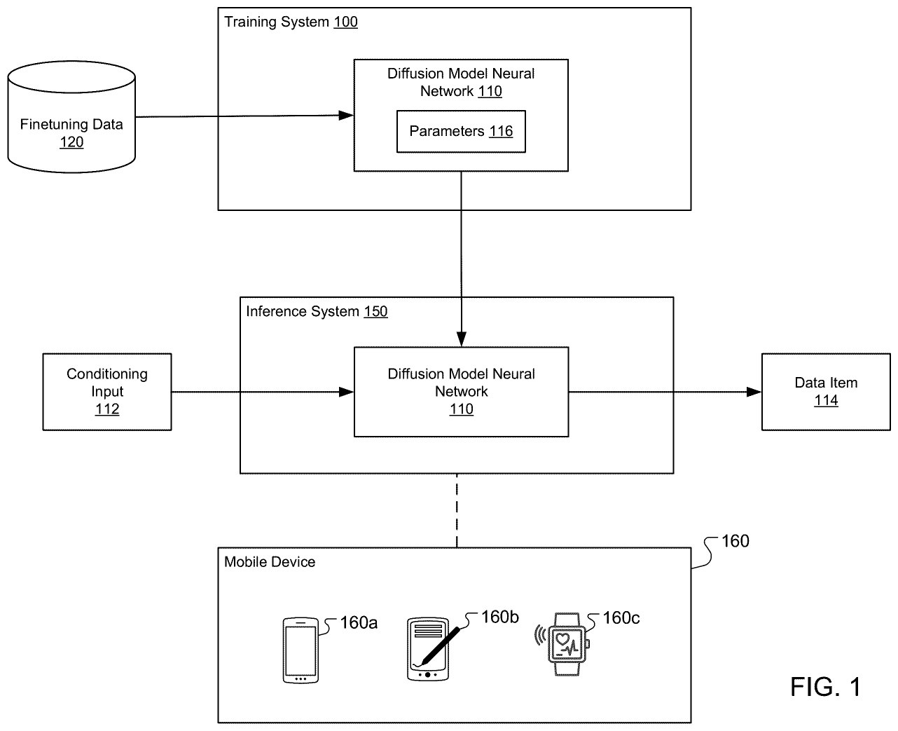

FIG. 1 shows an example training system 100 and an example inference system 150. The training system 100 and the inference system 150 are examples of a system implemented as computer programs on one or more computers in one or more locations, in which the systems, components, and techniques described below can be implemented.

The training system 100 trains a diffusion model neural network 110 for the inference system 150 to use, i.e., to generate data items 114 conditioned on conditioning inputs 112.

Because of the computationally intensive nature of the training process, the training system 100 can be implemented on a distributed computing system, e.g., a datacenter, having multiple, e.g., tens or hundreds of, computers. In contrast, the inference system 150 can be implemented on a mobile computing device 160 with limited computational resources, power resources, or both.

As illustrated in FIG. 1, examples of the mobile computing device 160 include a smartphone 160a, tablet 160b, and smartwatch or wearable device 160c. Additional examples mobile computing device 160 include an eNotebook, Netbook, smart speaker, desktop computer, and laptop or other mobile computer.

Generally, the conditioning input 112 characterizes one or more desired properties for the data item 114, i.e., characterizes one or more properties that the data item 114 generated by the inference system 150 should have.

The diffusion model neural network 110 can be configured through training to generate any of a variety of data items conditioned on any of a variety of conditioning inputs.

For example, the diffusion model neural network 110 can be configured to generate audio data, e.g., a waveform of audio or a spectrogram, e.g., a mel-spectrogram or a spectrogram where the frequencies are in a different scale, of the audio.

In this example, the conditioning input can be text, e.g., in the form of a text prompt, or features of text that the audio should represent, i.e., so that the system serves as a text-to-speech machine learning model that converts text or features of the text to audio data for an utterance of the text being spoken.

As another example, the conditioning input can identify a desired speaker for the audio, i.e., so that the system generates audio data that represents speech by the desired speaker.

As another example, the conditioning input can characterize properties of a song or other piece of music, e.g., lyrics, genre, and so on, so that the system generates a piece of music that has the properties characterized by the conditioning input.

As another example, the conditioning input can specify a classification for the audio data into a class from a set of possible classes, so that the system generates audio data that belongs to the class. For example, the classes can represent types of musical instruments or other audio emitting devices, i.e., so that the system generates audio that is emitted by the corresponding class, or types of animals, i.e., so that the system generates audio that represents noises generated by the corresponding animal, and so on.

As another particular example, the data item can be an image, such that the inference system 150 can perform conditional image generation by generating the intensity values of the pixels of the image. In general the conditioning input can specify one or more characteristics for the image.

In this particular example, the conditioning input can be a sequence of text, e.g., in the form of a text prompt, and the data item can be an image that describes the text, i.e., the conditioning input can be a caption for the image.

As yet another particular example, the conditioning input can be an object detection input that specifies one or more bounding boxes and, optionally, a respective type of object that should be depicted in each bounding box.

As yet another particular example, the conditioning input can specify an object class from a plurality of object classes to which an object depicted in the image should belong.

As another example, the conditioning input can specify one or more images.

For example, the conditioning input can specify an image at a first resolution and the data item can include the image at a second, higher resolution.

For example, the conditioning input can specify an image and the data item can comprise a de-noised, enhanced, stylized, or otherwise edited version of the image.

As yet another particular example, the conditioning input can specify an image including a target entity for detection, e.g. a tumor, and the data item can comprise the image without the target entity, e.g., to facilitate detection of the target entity by comparing the images.

As yet another particular example, the conditioning input can be a segmentation that assigns each of a plurality of pixels of the image to a category from a set of categories, e.g., that assigns to each pixel a respective one of the category.

As yet another example, the conditioning input can be a different type of structured input, e.g., a mesh or a graph that specifies properties of the image to be generated.

More generally, the conditioning input can include one or more different types of inputs of one or more different modalities, e.g., only text, only one or more images, both text and one or more images, and so on.

As yet another example, the data item can be a video. Again the conditioning input can specify one or more characteristics for the video.

As a particular example, the conditioning input can include text and the data item can be a video described by the text.

As yet another particular example, the conditioning input can include one or more images and the data item can be a video that completes the one or images, e.g., video starting from the one or more images.

More generally, the task of generating the data item can be any task that outputs continuous data conditioned on a conditioning input. For example, the output can be an output of a different sensor, e.g., a lidar point cloud, a radar point cloud, an electrocardiogram reading, and so on, and the conditioning input can represent the type of data that should be measured by the sensor. Where a discrete output is desired this can be obtained, e.g., by thresholding the outputs generated by the diffusion model neural network 110.

In some applications, the data item can be used in a control task to control an action of a mechanical agent acting in a real-world environment to perform a mechanical task. For example, the data item can be processed by a policy neural network of the agent to select one or more actions to be performed by the agent as part of the task. The agent may then perform the one or more actions. The data item (e.g., image) can, for example, characterize a state of the real-world environment that is predicted to be obtained by the agent performing the one or more actions. The conditioning input can, e.g., specify a state of the real-world environment and the one or more actions. As another example the conditioning input can specify a state of the real-world environment and the data item can be used to select one or more actions to be performed by the mechanical agent to perform a task (i.e. the diffusion model neural network can represent an action selection policy).

In any of the above examples, the data item generated using the diffusion model neural network can either be a data item in the output space, i.e., so that the values in the data item are the values of a data item of the appropriate type, e.g., values of image pixels, amplitude values of an audio signal, and so on, or a data item in a latent space, i.e., so that the values in the output data item are values in a latent representation of a data item in the output space.

When the data item is generated in a latent space, the inference system 150 can generate a final data item in output space by processing the data item in the latent space using a decoder neural network, e.g., one that has been pre-trained in an auto-encoder framework. During training, the inference system 150 can use an encoder neural network, e.g., one that has been pre-trained jointly with the decoder in the auto-encoder framework, to encode target data items in the output space to generate target outputs for the diffusion model neural network in the latent space.

The diffusion model neural network 110 can be initialized using a base diffusion model that has been pre-trained; the diffusion model neural network 110 can then be fine-tuned, where at least the fine-tuning takes place at the training system 100.

To fine-tune the diffusion model neural network 110, the training system 100 obtains fine-tuning data 120, e.g., as an upload by a user of the training system or from a server, and then trains the diffusion model neural network 110 to determine the trained values of the parameters 116 of the diffusion model neural network 110 based on optimizing an objective function using the fine-tuning data 120.

Generally, the fine-tuning data 120 obtained by the training system 100 will vary depending on the types of data items that the inference system 150 is configured to generate. For example, when the inference system 150 is configured to generate images, the fine-tuning data 120 can include a plurality of images. As another example, when the inference system 150 is configured to generate audio waveforms, the fine-tuning data 120 can include a plurality of audio waveforms.

In some implementations, each data item included in the fine-tuning data 120 is associated with a corresponding text caption or another text sequence that is descriptive of the content of the data item. For example, the fine-tuning data 120 can include a plurality of text-image pairs, where each text-image pair can include an image and a respective caption.

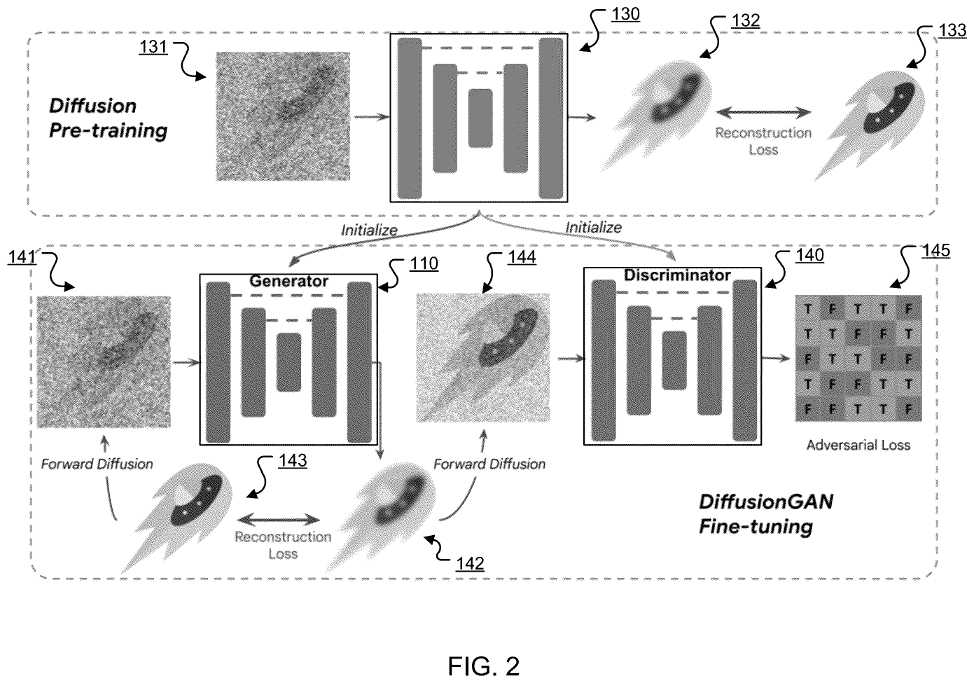

FIG. 2 is an example illustration of operations performed by the training system 100 to train the diffusion model neural network 110.

At a high level, the training system 100 trains the diffusion model neural network 110 under a generative adversarial network (GAN) framework, where the diffusion model neural network 110 can be the generator neural network that is paired with a discriminator neural network 140 in the GAN framework.

Prior to the GAN training, the generator neural network (the diffusion model neural network) 110 and the discriminator neural network 140 can be initialized using a base diffusion model 130 that has been pre-trained based on optimizing a pre-training objective function. That is, the diffusion model neural network 110 and the discriminator neural network 140 can start with the same or similar architecture and parameter values as the base diffusion model 130.

The base diffusion model 130 has been pre-trained, e.g., by the training system 100 or a different training system, on a large dataset of training data items based on optimizing a pre-training objective function to learn the pre-trained values of the parameters of the base diffusion model 130.

For example, the large dataset of training data items can include a large dataset of images where each image includes an array of pixels, a large dataset of videos where each video includes a temporal sequence of frames, a large dataset of audio samples, e.g., audio recordings or waveforms that represent the audio recordings, or a large multi-modal dataset that includes a combination of two or more of these datasets.

In the example of FIG. 2, the pre-training objective function used to pre-train the base diffusion model 130 includes a reconstruction loss, and the training data items used to pre-train the base diffusion model 130 are images that the base diffusion model 130 is trained to reconstruct as part of the pre-training.

In other examples, the training data items can include other types of data, e.g., videos, audio waveforms, sensor outputs, and the pre-training techniques described below can be similarly applied. Alternatively, in those other examples, the pre-training techniques used to pre-train the base diffusion model 130 can be different techniques, e.g., a pre-training technique that optimizes a score matching objective, a v-prediction objective, or another diffusion objective function.

During the pre-training, for each image 133 included in the large dataset, the base diffusion model 130 processes a diffusion input that includes a noisy representation 131 of the image and, when included, a text caption to generate a diffusion output from which a reconstruction 132 of the image can be derived.

For example, the diffusion output can define an estimated noise that needs to be removed from the noisy representation 131 in order to provide the image 133. In some implementations, the diffusion input also includes time index data characterizing a noise level of the noise that is included in the noisy representation 131 of the image.

In this example, using the pre-training objective function, the reconstruction 132 of the image can be compared with the image 133 from the large dataset to evaluate the performance of the base diffusion model 130 on noise estimation. Specifically, the reconstruction loss measures an error between the reconstruction 132 of the image and the image 133. For example, the reconstruction loss can be an L1 loss, an L2 loss, a mean squared error, a Huber loss, or another difference measure.

As another example, the diffusion output can include the reconstruction 132 of the image. As another example, the diffusion output can define an estimated noise that needs to be removed from the noisy representation in order to provide a latent representation of the image in the latent space that, when processed by a decoder neural network, can generate the reconstruction of the image in the output (pixel) space. In these examples, base diffusion model 130 can be trained based on optimizing a score matching objective, a v-prediction objective, or another diffusion objective function.

In the example of FIG. 2, the data items included in the fine-tuning data 120 are images. In other examples, the data items can include other types of data, e.g., videos, audio waveforms, sensor outputs, and the GAN training techniques described below can be similarly applied.

Under the GAN framework, the training system 100 trains the diffusion model neural network 110 to generate reconstructed images that are indistinguishable from the ground truth images from the fine-tuning data 120 obtained by the training system 100.

Additionally, the training system 100 trains the discriminator neural network 140 to tell apart the noisy reconstructed images that have been generated based on using the diffusion model neural network 110 and the ground truth images from the fine-tuning data 120, for example, by providing a prediction value of 1 if an input to the discriminator neural network 140 is classified as a ground truth image and 0 if noisy reconstructed image (or vice versa).

To that end, in some implementations, the discriminator neural network 140 can have a similar architecture as the diffusion model neural network 110, but with a different output layer that allows discriminator neural network 140 to generate an output that is a single prediction value based on aggregating the logits across multiple locations within a feature map that has the same dimensionality as the predicted image.

More specifically, the training system 100 performs the training over a plurality of training iterations. At each training iteration, the training system 100 obtains a plurality of images 143 (a “batch” or a “mini-batch” of images) sampled from the fine-tuning data 120. For each image 143 included in the batch, the training system 100 adds noise to the image 143 (i.e., performs a forward diffusion step) to generate a noisy representation 141 of the image and then processes the noisy representation 141 of the image and, when included, a text caption associated with the image 143 using the diffusion model neural network 110 to generate a diffusion output from which a reconstruction 142 of the image can be derived.

For example, the diffusion output can define an estimated noise that needs to be removed from the noisy representation 141 in order to provide the image 143. In some implementations, the diffusion input also includes time index data characterizing a noise level of the noise that is included in the noisy representation 141 of the image.

Having generated the reconstruction 142 for each image 143, the training system 100 adds noise to the reconstruction 142 (i.e., performs a forward diffusion step) to generate a noisy reconstruction 144, and then processes the noisy reconstruction 144 using the discriminator neural network 140 to generate a prediction value 145 for the noisy reconstruction 144. In effect, the discriminator neural network 140 produces an output which represents a difference between the noisy reconstructions 144 generated based on using the diffusion model neural network 110 and the ground truth images from the fine-tuning data 120. This is used as a training signal to adjust parameters of the diffusion model neural network 110, to encourage it to generate reconstructions 142 that match the ground truth images from the fine-tuning data 120.

Then, the training system 100 updates the values of the parameters of the diffusion model neural network 110 and the discriminator neural network 140 based on optimizing an objective function, e.g., based on applying an optimizer to the respective gradients of the objective function that have been computed with respect to the parameters of the neural networks 110, 140 through backpropagation.

By repeatedly performing training iterations using different batches of images sampled from the fine-tuning data 120, the training system 100 repeatedly updates the values of the parameters of the diffusion model neural network 110 and the discriminator neural network 140 beginning from their initial values, i.e., the pre-trained values of the parameters of the base diffusion model 130.

For example, the objective function can be an adversarial fine-tuning objective function that is in the form of:

$${min}_{θ} {max}_{ϕ} {𝔼}_{q ( {x}_{0} ) q ( {x}_{t - 1} \vert {x}_{0} ) , {p}_{θ} ( {x}_{0}^{′} ) {p}_{θ} ( {x}_{t - 1}^{′} \vert ( {x}_{0}^{′} )} [ \text{} {\underbrace{[ log ( {D}_{ϕ} ( {x}_{t - 1} , t ) ) ] + [ log ( 1 - {D}_{ϕ} ( {x}_{t - 1}^{′} , t ) ) ]}}_{adversarial loss} + {\underbrace{{λγ}_{t} {‖ {x}_{0} - {x}_{0}^{′} ‖}^{2}}}_{diffusion loss} ]$$

where θ represents the parameters of the generator neural network G_{θ} (the diffusion model neural network), ϕ represents the parameters of the discriminator neural network D_{ϕ}, x₀ represents an image included in the fine-tuning data, q(x₀) represents the data distribution of the images included in the fine-tuning data, and q(xₜ₋₁|x₀) represents a forward diffusion process performed on an image x₀ where noise is added to the image x₀. x′₀ represents a reconstruction of an image generated by the generator neural network, where x′₀=G_{θ}(xₜ, t)˜p_{θ}(x′₀). x′ₜ₋₁ represents a noisy reconstruction of an image that is generated by performing a forward diffusion process performed on a reconstruction x (of the image where noise is added to the reconstruction, where x′ₜ₋₁˜p_{θ}(x′ₜ₋₁|x′₀).

In the example above, the inclusion of the diffusion loss, which is implemented as an L2 loss between an image x₀ and a reconstruction x′₀ of the image, can stabilize the training. In other examples, the diffusion loss term can be implemented in different ways.

For example, the diffusion loss in the above can be replaced with a distillation loss that is in the form of:

$${ℒ}_{distill} = {‖ sg ( {G}^{teacher} ( {x}_{t} , t ) ) - {x}_{0}^{′} ‖}^{2} ,$$

where G^{teacher} represents a pre-trained teacher diffusion model having pre-trained parameter values that is configured to process a diffusion input that includes a noisy representation of the image and, when included, a text caption to generate a diffusion output from which a reconstruction of the image can be derived, and sg(.) represents a stop gradient operator that is applied to the parameters of the pre-trained teacher diffusion model to prevent the pre-trained values of these parameters from being modified during the GAN training.

As another example, the diffusion loss in the above can be replaced with an EMA distillation loss that is in the form of:

$${ℒ}_{ema} = {‖ sg ( {G}_{θ}^{EMA} ( {x}_{t} , t ) ) - {x}_{0}^{′} ‖}^{2} ,$$

where G_{θ}^{EMA} represents the exponential moving average of the parameter values of the generator neural network G_{θ}. Given that the generator neural network G_{θ} has been initialized using a base diffusion model, the EMA mechanism effectively retains a substantial portion of the already learned knowledge of base diffusion model. This EMA distillation loss can ensure that the essence of the knowledge learned by the base diffusion model is conserved, while providing more flexibility (relative to the example above).

After training, the diffusion model neural network 110 can be used in the inference system 150 of FIG. 1 to generate new data items 114 conditioned on new conditioning inputs 112. On the other hand, the discriminator neural network 140 is used during training of the diffusion model neural network 110, and if desired, may be discarded after training as then only the diffusion model neural network 110 may be needed.

For example, the training system 100 can output data specifying the trained diffusion model neural network 110, including parameter data defining the trained values of the parameters 116 of the diffusion model neural network 110 and, optionally, architecture data defining the architecture of the diffusion model neural network 110 to the inference system 150—and the inference system 150 deploys the trained diffusion model neural network 110 on a mobile computing device to perform inference, i.e., to generate new data items 114 conditioned on new conditioning inputs 112. As mentioned above the inference system can use the trained diffusion model neural network 110 to generate any of a variety of different types of data items, e.g., images, videos, audio waveforms, sensor outputs, and so on.

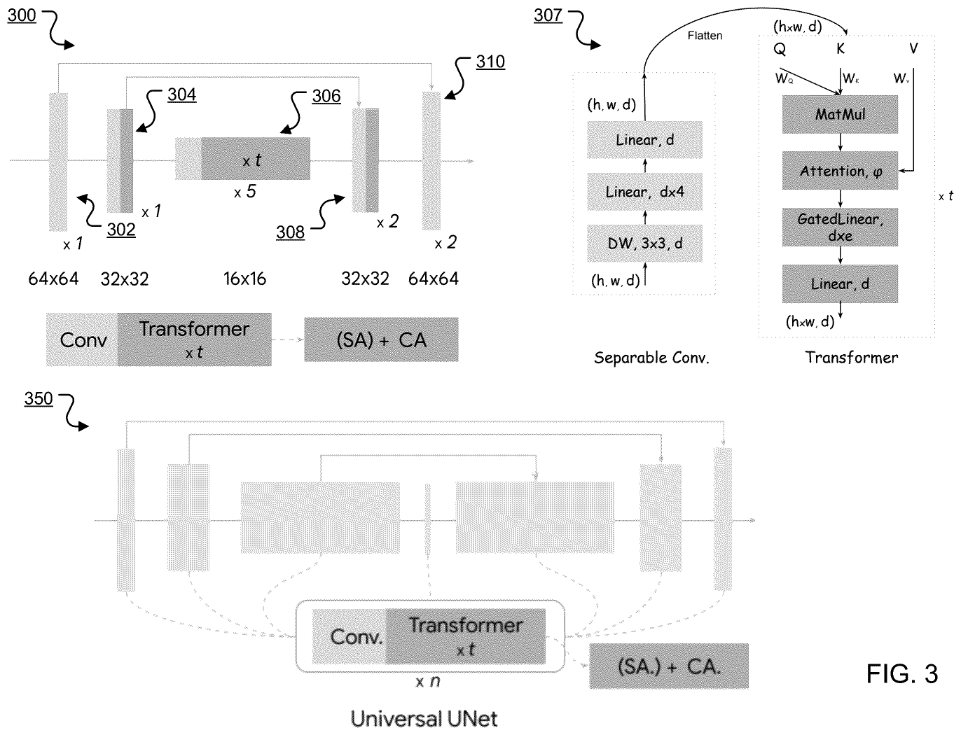

FIG. 3 shows an example of a neural network architecture 300 of the diffusion model neural network 110.

The diffusion model neural network 110 includes a sequence of neural network blocks. A neural network “block” refers to a group of one or more neural network layers in a neural network. The sequence of neural network blocks include: one or more initial neural network blocks, followed by one or more intermediate neural network blocks, followed by one or more final neural network blocks.

For example, in FIG. 3, the diffusion model neural network 110 includes an initial neural network blocks 302, followed by intermediate neural network blocks 304, 306, 308, and followed by a final neural network block 310. Generally, the initial and final neural network blocks process data that has a higher dimensionality than the data processed by the intermediate neural network blocks. The intermediate neural network blocks may thus also be referred to as the “bottleneck” blocks, because they operate on data that has a lower dimensionality than the input data, output data, or both. For example, the neural network blocks 304, 306, 308 may be referred to as the “bottleneck” blocks in FIG. 3.

The one or more initial neural network blocks are each a respective convolution (“Conv”) block. A convolution block is a block that includes at least one convolution layer that can apply a convolution operation to a layer input to generate a layer output.

In particular, each initial neural network block includes at least one separable convolution layer, e.g., a depth-wise separable convolution layer or a spatial separable convolution layer, that applies a separable convolution operation. In some implementations, each initial neural network block does not include any attention mechanism. In other words, no attention layer is included in any of the one or more initial neural network blocks.

For example, in FIG. 3, the neural network block 302 is an initial neural network block that includes a depth-wise separable convolution layer or a spatial separable convolution layer. The neural network block 302 excludes, i.e., does not include any, attention layers.

The neural network block 302 processes data that has a higher dimensionality relative to the data processed by the intermediate neural network blocks 304, 306, 308. In particular, the neural network block 302 receives a block input that has spatial dimensions 64×64. That is, the neural network block 302 receives a block input that that includes pixels arranged in a two-dimensional map that has the size of 64×64, with each pixel having a respective value for each of one or more channels. The neural network block 302 process the block input that has the higher dimensionality to generate a block output based on applying a separable convolution operation (but no attention operation) to the block input.

The one or more intermediate neural network blocks are each a respective attention (“Transformer”) block. An attention block is a block that includes at least one attention layer that can apply an attention operation to a layer input to generate a layer output.

In some implementations, the one or more intermediate neural network blocks include a first intermediate neural network block, followed by a second intermediate neural network block. The first intermediate neural network block includes a separable convolution layer that applies a separable convolution operation and one or more cross-attention layers that each apply a cross-attention operation. The second intermediate neural network block includes a separable convolution layer, one or more cross-attention layers, and one or more self-attention layers that each apply a self-attention operation.

In these implementations, the first intermediate neural network block can be configured to process a first intermediate block input having a first lower dimensionality to generate a first intermediate block output based on applying the convolution operation and a cross-attention operation to the first intermediate block input. The second intermediate neural network block can be configured to process a second intermediate block input having a second lower dimensionality, where the second lower dimensionality is lower than the first lower dimensionality, to generate a second intermediate block output based on applying the convolution operation, the cross-attention operation, and a self-attention operation to the second intermediate block input.

In some implementations, an intermediate neural network block includes an attention layer, e.g., a cross-attention layer or a self-attention layer, that uses a shared key-value projection matrix to generate the keys and values and therefore applies an attention operation, e.g., a cross-attention or self-attention operation, using the keys and values that are identical to each other. Using a shared projection matrix and rather than different projection matrices to generate the keys and values for the attention operations can reduce the total parameter count (and therefore the memory footprint) of the diffusion model neural network.

In some implementations, an intermediate neural network block includes an attention layer, e.g., a cross-attention layer or a self-attention layer, that uses a ReLU activation function (rather than a softmax function) to generate an output of the attention layer. For example, an output of the attention operation may be determined as relu(K^{T}Q) V where K, Q, and V are the keys, queries, and values (where typically each key or query or value is a vector) derived from an input to the attention layer.

In some implementations, an intermediate neural network block includes one or more feed-forward layers and one or more Swish activation layers. For example, the one or more feed-forward layers can be arranged subsequent to the attention layer within the intermediate neural network block.

In some implementations, each intermediate neural network block also includes one or more convolution layers, i.e., in addition to the one or more attention layers.

For example, in FIG. 3, the neural network block 304 is an intermediate neural network block that includes a cross-attention (“CA”) layer that applies a cross-attention operation. The neural network block 304 also includes a separable convolution layer, e.g., a depth-wise separable convolution layer or a spatial separable convolution layer. Optionally, the neural network block 304 also includes a self-attention (“SA”) layer that applies a self-attention operation.

The neural network block 304 processes data that has a first lower dimensionality that is lower than the higher dimensionality. In particular, the neural network block 304 receives a block input that has spatial dimensions 32×32. That is, the neural network block 304 receives a block input that that includes pixels arranged in a two-dimensional map that has the size of 32×32, with each pixel having a respective value for each of one or more channels. The neural network block 304 process the block input that has the first lower dimensionality to generate a block output based on applying a separable convolution operation and an attention operation to the block input.

In FIG. 3, the neural network block 306 is another intermediate neural network block that includes t cross-attention (“CA”) layers that each apply a cross-attention operation, where t can be any positive integer greater than or equal to one. The neural network block 306 also includes a separable convolution layer, e.g., a depth-wise separable convolution layer or a spatial separable convolution layer. Optionally, the neural network block 306 also includes t self-attention (“SA”) layers that each apply a self-attention operation.

Further, in FIG. 3, the neural network block 306 is repeated for a total of 5 times in the diffusion model neural network 110, i.e., the diffusion model neural network 110 includes a total of 5 instances of the neural network block 306, where the instances of the neural network block 306 are stacked (i.e., arranged in a sequence with the output of any block except the last being an input to another of the blocks).

The neural network block 306 processes data that has a second lower dimensionality that is even lower than the first lower dimensionality. In particular, the neural network block 306 receives a block input that has spatial dimensions 16×16. That is, the neural network block 306 receives a block input that that includes pixels arranged in a two-dimensional map that has the size of 16×16, with each pixel having a respective value for each of one or more channels. The neural network block 306 process the block input that has the second lower dimensionality to generate a block output based on applying a separable convolution operation and one or more attention operations to the block input.

The diagram 307 on the right-hand side shows an example architecture of the neural network block 306. As shown, the neural network block 306 includes a depth-wise separable convolution sub-layer that receives a three-dimensional input tensor having a dimension of (h, w, d) and generates a three-dimensional output tensor also having a dimension of (h, w, d), followed by t cross-attention layers that each receive a two-dimensional input tensor having a dimension of (h×w, d) and generate a two-dimensional output tensor also having a dimension of (h×w, d).

The depth-wise separable convolution layer includes a depth-wise convolution sub-layer with kernel size 3×3, a linear sub-layer with d×4 units, and another linear sub-layer with d units.

Each cross-attention layer includes a matrix multiplication sub-layer that performs a matrix multiplication between the query Q matrix (a matrix having elements that represent the queries) and key K matrix that are generated from the input to the cross-attention layer, followed by an attention sub-layer having parameters ϕ that compute the attention weights based on the product matrix generated by the matrix multiplication sublayer and the value V matrix that is generated from the input to the cross-attention layer, followed by a gated linear sub-layer having a dimension of d×e, where e is the expansion factor in the gated linear sub-layer, followed by a linear sub-layer with d units.

In FIG. 3, the neural network block 308 is another intermediate neural network block that includes a cross-attention (“CA”) layer that applies a cross-attention operation. The neural network block 306 also includes a separable convolution layer, e.g., a depth-wise separable convolution layer or a spatial separable convolution layer. Optionally, the neural network block 306 also includes a self-attention (“SA”) layer that applies a self-attention operation.

Further, in FIG. 3, the neural network block 308 is repeated for a total of 2 times in the diffusion model neural network 110, i.e., the diffusion model neural network 110 includes a total of 2 instances of the neural network block 308, where the instances of the neural network block 308 are stacked (i.e., arranged in a sequence with the output of the one of the blocks being an input to another of the blocks).

The neural network block 308 processes data that has the first lower dimensionality that is lower than the higher dimensionality. In particular, the neural network block 308 receives a block input that has spatial dimensions 32×32. That is, the neural network block 308 receives a block input that that includes pixels arranged in a two-dimensional map that has the size of 32×32, with each pixel having a respective value for each of one or more channels. The neural network block 308 process the block input that has the first lower dimensionality to generate a block output based on applying a separable convolution operation and one or more attention operations to the block input.

Like the initial neural network blocks, the one or more final neural network blocks are each a respective convolution block that includes at least one convolution layer that can apply a convolution operation to a layer input to generate a layer output. In particular, each final neural network block includes at least one separable convolution layer, e.g., a depth-wise separable convolution layer or a spatial separable convolution layer, that applies a separable convolution operation. In some implementations, each final neural network block does not include any attention mechanism. In other words, no attention layer is included in any of the one or more final neural network blocks.

For example, in FIG. 3, the neural network block 310 is a final neural network block that includes a depth-wise separable convolution layer or a spatial separable convolution layer. The neural network block 310 excludes, i.e., does not include any, attention layers.

The neural network block 310 processes data that has the higher dimensionality. In particular, the neural network block 310 receives a block input that has spatial dimensions 64×64. That is, the neural network block 310 receives a block input that that includes pixels arranged in a two-dimensional map that has the size of 64×64, with each pixel having a respective value for each of one or more channels. The neural network block 310 process the block input that has the higher dimensionality to generate a block output based on applying a separable convolution operation (but no attention operation) to the block input.

Further, in FIG. 3, the neural network block 310 is repeated for a total of 2 times in the diffusion model neural network 110, i.e., the diffusion model neural network 110 includes a total of 2 instances of the neural network block 310, where the instances of the neural network block 310 are stacked (i.e., arranged in a sequence with the output of the one of the blocks being an input to another of the blocks).

Therefore, while each of the initial neural network block 302, the intermediate neural network blocks 304, 306, 308, and the final neural network block 310 include one or more respective separable convolution layers, only some of the neural network blocks (more specifically, the intermediate neural network blocks 304, 306, 308) include cross-attention layers, and even fewer, if any, of these neural network blocks include self-attention layers.

It will be understood that the neural network architecture 300 is distinct from conventional neural network architectures in a variety of aspects.

FIG. 3 also shows an example of another neural network architecture 350 of a diffusion model neural network. The neural network architecture 350 may correspond to the UVIT architecture described in Hoogeboom, Emiel, Jonathan Heek, and Tim Salimans. simple diffusion: End-to-end diffusion for high resolution images. International Conference on Machine Learning. PMLR, 2023.

As illustrated, the neural network architecture 350 includes a plurality of neural network blocks. Each neural network block includes one or more convolution layers and one or more attention layers, e.g., one or more cross-attention layers, one or more self-attention layers, or both. Hence, in the neural network architecture 350, attention layers are used to process data that has a higher dimensionality because they are included in the initial and final neural network blocks. Also, in the neural network architecture 350, the one or more convolution layers are standard convolution layers that each applies a standard convolution operation.

In contrast, the convolution layers included in the neural network architecture 300 are separable convolution layers, e.g., depth-wise separable convolution layers or spatial separable convolution layers, that each apply a separable convolution operation. Further, the neural network architecture 300 does not include any attention layer that processes data that has a relatively higher dimensionality because no attention layer is included in the initial or final neural network blocks. Put another way, the attention layers included in the neural network architecture 300 are consolidated near the center of the neural network architecture 300, i.e., the neural network architecture 300 includes the attention layers within the bottleneck blocks (and not within the initial or final neural network blocks).

Such distinctions can yield numerous benefits in terms of computational cost reductions. For one, replacing standard convolution layers with lightweight separable convolution layers can reduce the number of multiplication computations required by the convolution operations. For another, given that the computational cost of the attention operation is quadratically proportional to the dimension (sequence length) of the input, the computation involved in the attention operations becomes less resource-intensive because the attention layers are more centered at the bottleneck and hence process data that has a relatively lower dimensionality.

The reduction in resource consumption allows the diffusion model neural network having the neural network architecture 300 to run locally on a mobile computing device or some other edge computing device with limited computational power or resources, e.g., a smartphone or a tablet. Put another way, the diffusion model neural network having the neural network architecture 300 is more practical than other diffusion model neural networks that are computationally too demanding to run on a mobile computing device.

In some implementations, the neural network architecture 300 can be automatically determined by the training system 100 or another neural architecture search system by searching through a predetermined search space of possible architectures that is defined by the neural network architecture 350, in order to reduce resource consumption of a diffusion model neural network having the neural network architecture 350 at inference time.

For example, after having obtained data specifying the neural network architecture 350, the training system 100 can generate a search space that includes one or more instances of each component included in the neural network architecture 350, and then perform a neural architecture search process to search through the search space. As part of the neural architecture search process, certain instances may be pruned or otherwise modified, e.g., based on quality metrics evaluated based on output data items generated by the diffusion model neural network, resulting in a pruned or modified architecture which can then be used as the neural network architecture 300.

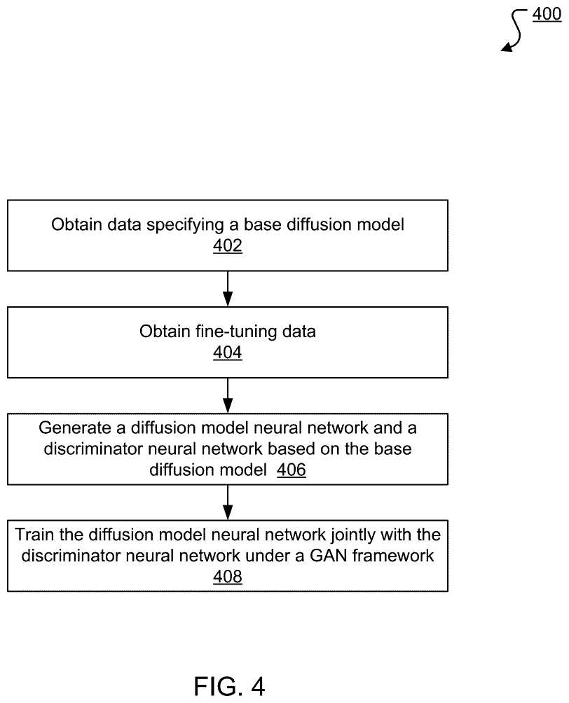

FIG. 4 is a flow diagram of an example process 400 for training a diffusion model neural network. For convenience, the process 400 will be described as being performed by a system of one or more computers located in one or more locations. For example, a training system, e.g., the training system 100 depicted in FIG. 1, appropriately programmed in accordance with this specification, can perform the process 400.

The system obtains data specifying a base diffusion model that has been pre-trained based on optimizing a pre-training objective function (step 402).

The system obtains fine-tuning data (step 404). The fine-tuning data includes data items. For example, the data items can be images, videos, audio waveforms, sensor outputs, and so on. Optionally, for each data item, the fine-tuning data also includes a text caption associated with the data item.

The system generates a diffusion model neural network and a discriminator neural network based on the base diffusion model (step 406). That is, the diffusion model neural network and the discriminator neural network can start with the same or similar architecture and parameter values as the base diffusion model.

The system trains the diffusion model neural network jointly with the discriminator neural network under a generative adversarial network (GAN) framework (step 408). The diffusion model neural network can correspond to a generator neural network under the GAN framework. The system performs the training over a plurality of training iterations.

At each training iteration, the system obtains a batch of data items sampled from the fine-tuning data. For each data item included in the batch, the system adds noise to the data item to generate a noisy representation of the data item and then processes the noisy representation of the data item and, when included, a text caption associated with the data item using the diffusion model neural network to generate a diffusion output from which a reconstruction of the data item can be derived.

Having generated the reconstruction for each data item, the system adds noise to the reconstruction to generate a noisy reconstruction, and then processes the noisy reconstruction using the discriminator neural network to generate a prediction value for the noisy reconstruction.

Then, the system updates the values of the parameters of the diffusion model neural network and the discriminator neural network based on optimizing an objective function, e.g., based on applying an optimizer to the respective gradients of the objective function that have been computed with respect to the parameters of the neural networks through backpropagation. An example of the objective function is described above with reference to FIG. 2.

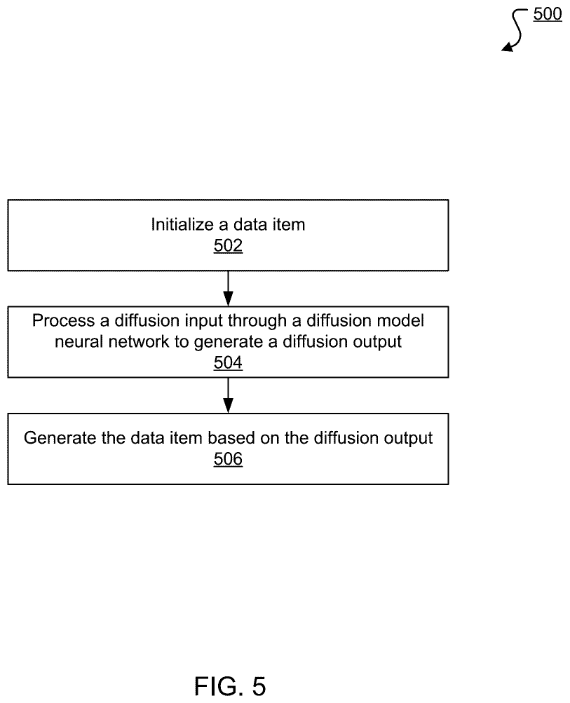

FIG. 5 is a flow diagram of an example process 500 for generating a data item by using a diffusion model neural network. For convenience, the process 500 will be described as being performed by a system of one or more computers located in one or more locations. For example, an inference system, e.g., the inference system 150 depicted in FIG. 1, appropriately programmed in accordance with this specification, can perform the process 500.

The diffusion model neural network includes one or more initial neural network blocks, followed by one or more intermediate neural network blocks, followed by one or more final neural network blocks.

Generally, the system generates a data item in response to a request received by the system, e.g., from a user of the system. For example, the data item can be an image, a video, an audio waveform, or a sensor output.

In some implementations, the system receives the request as a part of, or in association with, a conditioning input. As a particular example, the conditioning input can be a text prompt. A user can submit the text prompt in any of a variety of ways, e.g., by entering text using an input device or by submitting an audio input that is transcribed by the system into text. Other examples of the conditioning input have been described above with reference to FIG. 1.

To generate the data item, the system initializes the data item, i.e., generates an initial representation of the data item (step 502).

The initial representation of the data item has the same dimensionality as the data item to be generated by the system in response to the request but has noisy values. For example, the system can initialize the data item, i.e., can generate the initial representation of the data item, by sampling each value in the data item from a corresponding noise distribution, e.g., a Gaussian distribution or a different noise distribution. That is, the data item includes multiple values and the initial representation of the data item includes the same number of values, with each value being sampled from a corresponding noise distribution.

The system processes a diffusion input through the one or more initial neural network blocks, the one or more intermediate neural network blocks, and the one or more final neural network blocks to generate a diffusion output (step 504). The first one of the initial neural network blocks is the neural network block that receives the diffusion input; the last one of the final neural network blocks is the neural network block that generates the diffusion output.

The diffusion input includes the initial representation of the data item. Optionally, when provided, diffusion input also includes the conditioning input, or data derived from the conditioning input, e.g., an embedding of the conditioning input that is generated by an embedding neural network from processing the conditioning input. Optionally, the diffusion input further includes time index data characterizing a noise level of the noise that is included in the initial representation of the data item.

The system generates the data item based on the diffusion output (step 506).

In some implementations, the data item can be generated directly, e.g., where the diffusion output of the diffusion model neural network includes the data item.

In some implementations, the data item can be generated indirectly. For example, the diffusion output can define an estimated noise that is included in the initial representation, and the system can generate the data item based on denoising the initial representation using the diffusion output, e.g., based on updating the initial representation to remove the estimated noise from the initial representation.

In some implementations where the data item is generated in a latent space, the system can generate the data item in output space by processing the data item in the latent space using a decoder neural network.

Notably, the system generates the data item by performing a single-step denoising process using the diffusion model neural network. That is, unlike many conventional systems that generate a data item by using a diffusion model to execute a reverse diffusion process across multiple update iterations to progressively remove the noise from an initial representation of the data item, such that a different intermediate representation of the data item is generated at each of the multiple update iterations and that the data item is generated after the last of the multiple update iterations, the system described in this specification performs a single forward pass through the diffusion model neural network to generate the diffusion output that can be used to generate the data item. The single-step denoising process not only enables the data item to be generated faster but also with reduced resource consumption compared with the reverse diffusion process across multiple update iterations.

For example, the data system can store the data item in an output data repository or provide the data item for use for some other immediate purpose, e.g., present the data item for display to the user that submitted the text prompt.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising one or more computers and one or more storage devices storing instructions that when executed by the one or more computers cause the one or more computers to implement a diffusion model neural network that generates a data item by performing a denoising process, wherein the diffusion model neural network comprises one or more initial neural network blocks followed by one or more intermediate neural network blocks followed by one or more final neural network blocks, and wherein:
each initial neural network block is configured to process an initial block input having a higher dimensionality to generate an initial block output based on applying a convolution operation to the initial block input;
each intermediate neural network block is configured to process an intermediate block input having a lower dimensionality that is lower than the higher dimensionality to generate an intermediate block output based on applying the convolution operation and an attention operation to the intermediate block input; and
each final neural network block is configured to process a final block input having the higher dimensionality to generate a final block output based on applying the convolution operation to the final block input.

2. The system of claim 1, wherein each initial neural network block comprises one or more depth-wise separable convolution layers, and wherein the convolution operation is a depth-wise separable convolution operation.

3. The system of claim 1, wherein each initial neural network block does not include any attention layer.

4. The system of claim 1, wherein the one or more intermediate neural network blocks comprise a first intermediate neural network block followed by a second intermediate neural network block, and wherein:
the first intermediate neural network block is configured to process a first intermediate block input having a first lower dimensionality to generate a first intermediate block output based on applying the convolution operation and a cross-attention operation to the first intermediate block input; and
the second intermediate neural network block is configured to process a second intermediate block input having a second lower dimensionality to generate a second intermediate block output based on applying the convolution operation, the cross-attention operation, and a self-attention operation to the second intermediate block input.

5. The system of claim 4, wherein the second lower dimensionality is lower than the first lower dimensionality.

6. The system of claim 1, wherein applying the attention operation comprises applying the attention operation over keys and values that have been generated using a same projection matrix.

7. The system of claim 1, wherein applying the attention operation comprises applying a ReLU activation function to generate an output of the attention operation.

8. The system of claim 1, wherein generating the data item by performing the denoising process comprises:
processing a diffusion input that comprises an initial representation of the data item through the one or more initial neural network blocks, the one or more intermediate neural network blocks, and the one or more final neural network blocks to generate a diffusion output; and
updating the initial representation of the data item using the diffusion output to generate the data item.

9. The system of claim 8, wherein the diffusion input comprises a conditioning input.

10. The system of claim 8, wherein the diffusion output defines a noise estimate for the initial representation of the data item.

11. The system of claim 1, wherein the diffusion model neural network has an architecture that is determined by searching through a predetermined search space of possible architectures to reduce resource consumption of the diffusion model neural network having the determined architecture.

12. The system of claim 1, wherein the data item is an image, a video, an audio waveform, or a sensor output.

13. A method performed by one or more computers, the method comprising:
generating a data item by performing a denoising process using a diffusion model neural network, wherein the diffusion model neural network comprises one or more initial neural network blocks followed by one or more intermediate neural network blocks followed by one or more final neural network blocks, and wherein the generating comprises:
processing, by each initial neural network block, an initial block input having a higher dimensionality to generate an initial block output based on applying a convolution operation to the initial block input;
processing, by each intermediate neural network block, an intermediate block input having a lower dimensionality that is lower than the higher dimensionality to generate an intermediate block output based on applying the convolution operation and an attention operation to the intermediate block input; and
processing, by each final neural network block, a final block input having the higher dimensionality to generate a final block output based on applying the convolution operation to the final block input.

14. The method of claim 13, wherein each initial neural network block comprises one or more depth-wise separable convolution layers, and wherein the convolution operation is a depth-wise separable convolution operation.

15. The method of claim 13, wherein each initial neural network block does not include any attention layer.

16. The method of claim 13, wherein the one or more intermediate neural network blocks comprise a first intermediate neural network block followed by a second intermediate neural network block, and wherein:
the first intermediate neural network block is configured to process a first intermediate block input having a first lower dimensionality to generate a first intermediate block output based on applying the convolution operation and a cross-attention operation to the first intermediate block input; and
the second intermediate neural network block is configured to process a second intermediate block input having a second lower dimensionality to generate a second intermediate block output based on applying the convolution operation, the cross-attention operation, and a self-attention operation to the second intermediate block input.

17. The method of claim 16, wherein the second lower dimensionality is lower than the first lower dimensionality.

18. The method of claim 13, wherein applying the attention operation comprises applying the attention operation over keys and values that have been generated using a same projection matrix.

19. The method of claim 13, wherein applying the attention operation comprises applying a ReLU activation function to generate an output of the attention operation.

20. One or more non-transitory computer storage media storing instructions that when executed by one or more computers cause the one or more computers to implement a diffusion model neural network that generates a data item by performing a denoising process, wherein the diffusion model neural network comprises one or more initial neural network blocks followed by one or more intermediate neural network blocks followed by one or more final neural network blocks, and wherein:
each initial neural network block is configured to process an initial block input having a higher dimensionality to generate an initial block output based on applying a convolution operation to the initial block input;
each intermediate neural network block is configured to process an intermediate block input having a lower dimensionality that is lower than the higher dimensionality to generate an intermediate block output based on applying the convolution operation and an attention operation to the intermediate block input; and
each final neural network block is configured to process a final block input having the higher dimensionality to generate a final block output based on applying the convolution operation to the final block input.
